(19) United States
(12) Patent Application Publication
(10) Pub. No.: US 2004/0216847 A1
(43) Pub. Date: Nov. 4, 2004

(54) Portable architectural tool

(76) Inventors: David R. Hall, Provo, UT (US); Joe R. Fox, Provo, UT (US)

Correspondence Address: David R. Hall, 2185 S Larsen Pkwy, Provo, UT, 84606, US

(21) Appl. No.: 10/427,046

(22) Filed: Apr. 30, 2003

(51) Int. Cl. B44C 7/04

(52) U.S. Cl. 156/575; 156/577; 156/579

(57) ABSTRACT

A portable tool is disclosed that is useful for working architectural elements such as masticized tape. The tool features a tool body that forms a regular polygon having at least 6 planar surfaces. The planar surfaces of the tool body promote handling of the tool and are useful for directing and manipulating the work of the tool. The planar surfaces may also comprise protrusions, depressions, or other markings in aid of directing the work of the tool. The tool also comprises a head apparatus for applying and dispensing masticized tape. The tool body may comprise a container for storing and dispensing mastic. The tool further comprises a tapered universal fill nozzle having a plurality of diameters that will accommodate remote charging of the tool from mechanisms provided by a variety of manufacturers. Although the body of the tool is usually made of corrosion resistant metal, it may also be made of a polymer, a carbon composite, or combination thereof. The tool body may also be uniquely colored to further identify it from the tools of other manufacturers.

### RELATED APPLICATIONS

None

### BACKGROUND OF THE INVENTION

This invention relates to a portable tool useful for working architectural elements. Specifically, the invention relates to a tool for dispensing and applying masticized tape to the joints of architectural panels. More specifically, this invention discloses a tool having a body that forms a regular polygon having at least 6 planar surfaces.

The investigator is referred to the following U.S. references, and the references cited therein, as examples of the art relative to the tools of the present invention.

U.S. Pat. No. 4,208,239, to Lass, incorporated herein by this reference, teaches a tubular main body having a circular shape that is held by the operator. At one end of the body, a tape applicator head is provided and is supplied with tape cement from a remote supply under pressure. A supply roll of tape is fed through the applicator head onto the wall joint to be taped. In the applicator head, a pair of tape drive wheels engage the tape and press it against the wall for taping a seam. As the drive wheels pull the tape through the applicator head, dry wall cement is applied to the tape. A flexible wiper blade carried from the head presses the tape into engagement with the wall.

U.S. Pat. No. 5,535,926, to Blitz, incorporated herein by reference, discloses an apparatus for applying mastic to a selected surface and includes a container for mastic, a pump assembly, and a drywall tool or wand. The drywall tool has circular body that is held by the operator handling the tool. The pump is operated by an air compressor. The apparatus is mounted on a hand truck so that it may be removed to different locations.

U.S. Pat. No. 6,513,562, to Trout, incorporated herein by this reference, provides a unitary nozzle adjacent to a tubular body having a circular shape. The unitary design of the nozzle allows for the application of a cutter mechanism, wheels to provide motive force, and a mastic tube to supply mastic to the fill section.

U.S. Pat. No. 4,828,647, to Eccleston, incorporated herein by this reference, discloses an apparatus having a tubular housing which holds a supply of mastic. The tubular housing has a circular form and is attached to a main drive roller mounted at the forward end of the housing which rotates by friction as it is moved along a wall and tape drive roller means operated by the main drive roller and which feeds the tape forwardly.

U.S. Pat. No. 4,652,331, to Plasencia, incorporated herein by this reference, reveals a tape and adhesive applicator for dry wall taping that has an adhesive dispensing nozzle adapted to be mounted on a caulking gun and a applicator roll mounted adjacent the outlet of the nozzle. The body of the caulking gun receives a tubular supply of mastic and both the tubular supply and the body of the gun have a circular form. The loaded caulking gun is attached to the adhesive applicator which has a form similar to a four sided polygon.

U.S. Pat. No. 4,086,121, to Ames, incorporated herein by this reference, discloses a self-contained dry wall taper that has a hollow elongated body for holding mastic and supports a roll of tape with tape feeding means to deliver the tape applying wheels that in turn apply it to cover a joint. The applicator comprises a tape creasing disc that can be swung into operative position by the operator for providing a median crease along the length of the tape and for forcing the crease into the room corner. The elongated body has a circular form.

Further reference is made to U.S. Pat. Nos. 2,815,142, to Ames, and 3,260,638, to Hoveland, incorporated herein by this reference, depicting tools relevant to this application having tubular bodies with a circular form.

What is needed in the art is a tool body that has a non-circular shape to aid in reducing operator fatigue, to promote ease of handling of the tool, and in directing and manipulating the work of the tool at high speed, especially in close quarters and blind situations. A further need addressed by this application is to provide a universal fill nozzle adjacent the head apparatus that will accommodate attachment to a variety of supply sources.

### SUMMARY OF THE INVENTION

A portable, hand-held tool is presented herein that is useful for working architectural elements. The tool comprises a head apparatus, a tool body, and a control mechanism. The improvement in the tool is its polygonal body, having at least 6 planar surfaces. The body of the tool promotes handling and manipulation of the tool. The one or more planar surfaces of the tool body may also comprise protrusions, depressions, or other markings sensible to sight or touch, or both, that cooperate with the planar surfaces to identify the position and orientation of the tool while it is being worked, especially when the tool is working in a blind manner. The head apparatus may comprise such mechanical workings as a frame, brackets, wheels, ratchets, sprockets, springs, pawls, levers, tubes, wires, rollers, chains, scrapers, a blade, and fasteners that are formed by machining, casting, and molding, or a combination thereof. The head apparatus is suitable for measuring, shaping, and dispensing lengths of masticized tape that may be applied to the joints of architectural panels such as sheet rock and gypsum board. The polygonal body may consist of a tube for storing and dispensing mastic or other materials suitable for smoothing the joints between the panels. The tubular body is made from a sufficiently high-strength material that the body may be pressurized to accommodate either hydraulic or pneumatic evacuation of the mastic to the head apparatus. A mechanical means may also be used to evacuate the mastic from the tool body. The tool body may also house a discrete rigid or pliable container for storing and dispensing mastic. The tool body may comprise a fill nozzle for charging the tool body with mastic. The nozzle may have two or more outside diameters in order to accommodate a variety of the tools for remotely filling the body. The tool body may be colored to differentiate it from the tools of other manufacturers. Further, the tool may feature a device for storing and dispensing architectural tape. The control mechanism is preferably a bi-directional slide mechanism having a shape complimentary to that of the tool body, and it serves to actuate the head apparatus. The control mechanism may have at least one neutral position, at least one forward position, and at least one reverse position opposite its forward position. The relative positions of the slide actuator determine the functions of the head apparatus.

### BRIEF DESCRIPTION OF THE DRAWINGS

FIG. 1 is perspective view of a polygonal body.

FIG. 2 is a perspective view of an embodiment of an architectural tool of the present invention.

### DETAILED DESCRIPTION OF THE INVENTION

The preferred embodiments of the present invention will be further discussed in light of the following detailed description.

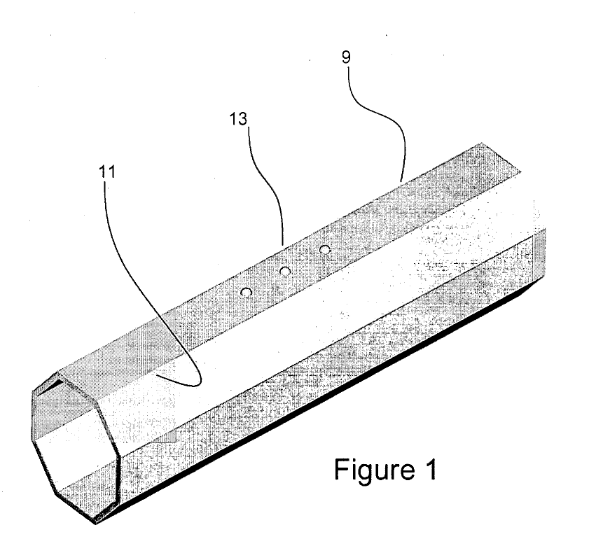

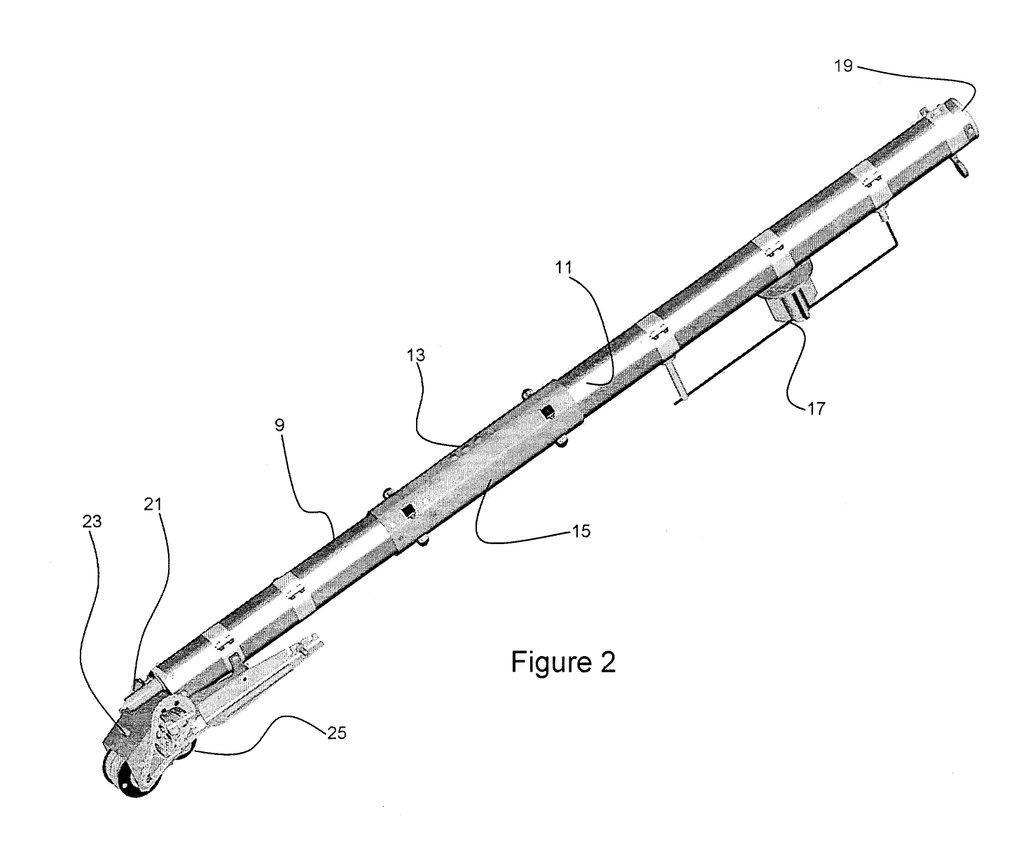

FIG. 1 is perspective view of an embodiment of the present invention. It comprises a tool body 9 that forms a regular polygon having at least 6 planar surfaces 11. The planar surfaces 11 of the body promote ease of handling of the tool, reduce operator fatigue, and act cooperatively with other components of the tool to direct its work. The body 11 may also comprise protrusions, depressions, and other markings 13, as shown in FIG. 2, that are sensible to sight and touch that further cooperate with the planar surfaces 11 in manipulating and directing the work of the tool. The planar surface markings 13 are especially useful when the tool is being used in a blind fashion, for example when it is being used in close quarters and around corners. Experts in the field using the tool have commented that the feel of the tool enables them to work faster with less fatigue and more accurately at high speed and in blind situations than when using tools having circular shaped bodies. The tool body 9 may be made from materials having sufficient strength to withstand field use and abuse as well as pressurization of the tool body by either hydraulic or pneumatic pressure for dispensing the desired materials. Such high strength materials include steel, stainless steel, aluminum, anodized aluminum, titanium, fiberglass, carbon composites, and high test polymers. The materials of the tool body may be further colored for identification and differentiation from tools of other manufacturers.

FIG. 2 is a perspective view of an embodiment of the present invention. The tool comprises a head apparatus 23, a tool body 9, a control mechanism 15, and a tape dispenser 17. The head apparatus, which is detachably connected to the tool body, may comprise a frame, brackets, wheels, ratchets, sprockets, springs, pawls, levers, tubes, wires, rollers, chains, scrapers, a blade, and fasteners formed by machining, casting, and molding, or a combination thereof. The body 9 may also be used to store and dispense mastic and other materials used in architectural construction. Accordingly, the body 9 may also be provided with openings at 19 that permit the attachment of valves and nozzles for filling the body with desired materials and for pressurizing the body using hydraulic, pneumatic, or mechanical means in aid of dispensing the desired material to the head apparatus. Opening 19 may also be used as a means for inserting rigid and pliable containers of desired materials for dispensation to the head apparatus 23. A control mechanism 15 having a form complimentary with the body of the tool is provided for actuating the head apparatus. The control mechanism moves rectilinearly along the axis of the tool body. The mechanism has at least one neutral position, at least one forward position, and at least one reverse position opposite the forward position. The relative positions of the control mechanism 15 determine the functions of the head apparatus. The control mechanism 13 may also comprise protrusions, depressions, and markings in aid of directing and manipulating the work of the tool.

Adjacent to the head apparatus 23, an embodiment of the present invention comprises a tapered universal fill nozzle for filling the body of the tool from a remote supply source, not shown. In the industry, in has been the practice of the various tool manufacturers to vary the diameter of the fill nozzle so that it only accepts the supply tools of their own make. This has required that interchangeable nozzles be provided in order to accommodate the variety of manufacturers' designs. To meet this need, the universal nozzle of the present invention is tapered having multiple diameters that will accommodate connection to a variety of tools from different manufacturers. Seals may also be added to the tapered nozzle to further promote connection and reduce leakage as materials are being transferred to the tool under pressure.

The tool body 9 further comprises the device 17 for storing and dispensing tape. A roll of tape which may be made of treated paper, a mesh paper, a polymer paper or mesh, a fiberglass composite tape material, a loaded tape, or a combination of these materials. Alternatively, the tape dispenser may be located remotely such on the operator on a stand along dispenser in the vicinity of the operator. A creasing mechanism 25 also forms part of the head apparatus. In order to reach into tight corners, masticized tape must be creased prior to application. One of the positions of the control mechanism may be used to actuate the crease mechanism 25 and then retract it when not in use.

What is claimed:

1. A portable tool, comprising:
a head apparatus for working architectural elements;
an elongate tool body connected to said apparatus;
wherein said body forms a regular polygon consisting of at least 6 planar surfaces.

2. The tool of claim 1, wherein the apparatus is detachably connected to the body.

3. The tool of claim 1 further comprising a control mechanism for actuating said apparatus.

4. The tool of claim 1, wherein the apparatus comprises a frame, brackets, wheels, ratchets, sprockets, springs, pawls, levers, tubes, wires, rollers, chains, scrapers, a blade, and fasteners formed by machining, casting, and molding, or a combination thereof.

5. The tool of claim 1, wherein the control apparatus or body comprise protrusions, depressions, or other markings that are sensible to sight and touch.

6. The tool of claim 1, wherein the body is suitable for storing and dispensing mastic.

7. The tool of claim 1, wherein the body is suitable for storing and dispensing tape.

8. The tool of claim 1, wherein the apparatus is suitable for applying mastic to tape and dispensing same.

9. The tool of claim 1, wherein the apparatus further comprises a means for creasing masticized tape.

10. The tool of claim 1 further comprising a universal fill spout comprising a plurality of diameters detachably connected to the body.

11. The tool of claim 1, wherein the body is made of a metal selected from the group consisting of steel, stainless steel, aluminum, anodized aluminum, and titanium.

12. The tool of claim 1, wherein the body is made of a polymeric material.

13. The tool of claim 1, wherein the body is made of a material comprising a carbon fiber composite.

14. The tool of claim 1, wherein the body is made of a material comprising glass fibers.

15. The tool of claim 1, wherein the body comprises a rigid or pliable, removable container for storing and dispensing mastic.

16. The tool of claim 1, wherein the body comprises a pneumatic means for evacuating mastic.

17. The tool of claim 1, wherein the body comprises a hydraulic means for evacuating mastic.

18. The tool of claim 1, wherein the body comprises a mechanical means for evacuating mastic.

19. The tool of claim 1, wherein the body is connected to a remote apparatus for dispensing mastic.

20. The tool of claim 1, wherein the body of the tool is colored to differentiate it from the tool of another manufacturer.

21. A tool for working masticized tape and for applying said tape to the joints formed by architectural panels, said tool comprising a tool body forming a regular polygon having at least 6 planar surfaces.
